(19) United States
(12) Patent Application Publication
(10) Pub. No.: US 2025/0263041 A1
(43) Pub. Date: Aug. 21, 2025

(54) SEAT BELT ADJUSTER FOR VEHICLES

(71) Applicant: SHENZHEN GLAMORTECH INDUSTRIAL CO., LTD, Shenzhen (CN)

(72) Inventor: Pengbo MU, Shenzhen (CN)

(21) Appl. No.: 18/772,296

(22) Filed: Jul. 15, 2024

(30) Foreign Application Priority Data
Feb. 20, 2024 (CN) 202420308990.4

(51) Int. Cl. B60R 22/46; B60R 22/34

(52) U.S. Cl. CPC B60R 22/46; B60R 2022/3402

(57) ABSTRACT

The present application discloses a seat belt adjuster for vehicles comprising an upper shell, a middle disk and a lower shell, the upper shell and the middle disk are fixedly connected together, and a first space for receiving a shoulder belt to pass therethrough is formed between the upper shell and the middle disk; a second space for receiving a waist belt to pass therethrough is formed between the middle disk and the lower shell, locking structures are provided on the middle disk and the lower shell at corresponding positions. The present application further provides a seat belt adjuster for vehicles comprising an upper shell, a lower shell and an elastomeric piece. The seat belt adjuster provided by the present application can adapt to different body types of occupants when a fixed three-point seat belt has been installed on the vehicle seat, thereby improving the safety of the occupant.

### TECHNICAL FIELD

The present application belongs to the technical field of vehicles, in particular to a seat belt adjuster for vehicles.

### BACKGROUND ART

Presently, seat belt arrangements applied on vehicle seats are widely used. In the event of an accident such as a collision, the seat belt is used to restrain the passengers and the driver from being thrown out of the seat to protect the passengers and the driver.

There are various types of seat belt apparatus, such as shoulder belts that restrain the movements of the shoulders and chests of the occupants, and waist belts that restrain the movements of the waists of the occupants. Seat belt apparatuses that are most widely used are three-point seat belt apparatuses. A three-point seat belt apparatus has a soft belt, one end of which is fixed to the vehicle body, and the other end of which is guided via a seat belt guide and wound on a seat belt winder fixed to the vehicle body. A seat belt tongue is slidably supported on the soft belt. A buckle is fixed to the vehicle body or the seat. When the seat belt is worn on an occupant, the seat belt tongue is inserted into the buckle and locked. The soft belt is tightened up by the winder and supported on the body of the occupant. At this point, the seat belt tongue divides the soft belt into two sections: one section of the soft belt between the seat belt guide and the seat belt tongue obliquely spans the upper body of the occupant and restrains the movement of the shoulders and chest of the occupant, and is referred to as a shoulder belt; the other section of the soft belt fixed between one end of the vehicle body and the seat belt tongue spans the pelvis of the occupant and restrains the movement of the waist of the occupant, and is referred to as a waist belt.

In the event of an accident such as a collision, an emergency locking mechanism of the seat belt winder acts to prevent the soft belt from being pulled out and restrains the occupant from moving forward, thereby protecting the safety of the occupant. Especially, some seat belt winder or buckles are provided with a pre-tensioner, and the pre-tensioner acts to tighten up the soft belt when an accident occurs, and eliminates the slack of the soft belt, thereby further improves the restraining and protective effect on the occupant.

However, when a child, a very thin occupant or a very tall occupant sits in the seat, he/she will find that the seat belt apparatus designed for adults is not suitable for him/her. The shoulder belt that is designed according to the average size of adults to diagonally span the shoulders and chest of an adult will run over the head of a child, a very thin occupant or a very tall occupant, and may even strangle the neck of the occupant. If the occupant wears an adult seat belt improperly, it will be very dangerous when an accident such as a collision occurs.

### SUMMARY OF THE INVENTION

The embodiments of the present application provide a seat belt adjuster, which is convenient to adapt to different body types of occupants when a fixed three-point seat belt has been installed on the vehicle seat, thereby improving the safety of the occupant.

In a first aspect, an embodiment of the present application provides a seat belt adjuster for vehicles, which comprises an upper shell, a middle disk and a lower shell, wherein
the upper shell and the middle disk are fixedly connected together, and a first space for receiving a shoulder belt to pass therethrough is formed between the upper shell and the middle disk;
the middle disk is rotatably connected with the lower shell, and a second space for receiving a waist belt to pass therethrough is formed between the middle disk and the lower shell, and locking structures are provided on respective positions at the middle disk and the lower shell.

Optionally, the middle disk is rotatably connected with the lower shell via a fixed rotational shaft.

Optionally, the fixed rotational shaft is arranged at one end of the middle disk and one end of the lower shell.

Optionally, the locking structures are arranged at an end of the middle disk away from the fixed rotational shaft and an end of the lower shell away from the fixed rotational shaft.

Optionally, the second space is arranged between the fixed rotational shaft and the locking structures.

Optionally, the upper shell and the middle disk are fixedly connected at a position that is at the same end as the locking structures.

Optionally, the first space is arranged at an end away from the position where the upper shell and the middle disk are fixedly connected, and the first space has no opening only at an end of the position where the upper shell and the middle disk are fixedly connected.

Optionally, the seat belt adjuster further comprises an elastic switch structure, and the elastic switch structure is connected with the locking structures.

Optionally, a first elastomeric member is provided in the second space, and the first elastomeric member is fixedly connected to the upper shell or the middle disk.

Optionally, the upper shell and/or the middle disk are/is provided with toothed structures.

In a second aspect, an embodiment of the present application further provides a seat belt adjuster for vehicles, which comprises an upper shell, an elastomeric piece and a lower shell, wherein
the upper shell is configured generally in a U-shape or a C-shape to form a first space for a shoulder belt to pass therethrough; the upper shell and the lower shell are rotatably connected with each other at a first end of the upper shell and a first end of the lower shell; a second space for a waist belt to pass therethrough is formed between the upper shell and the lower shell; snap lock structures are provided at a second end of the upper shell and a second end of the lower shell; and the elastomeric piece is arranged in the second space, and the elastomeric piece is squeezed to clamp the waist belt after the upper shell and the lower shell are locked by means of the snap lock structures.

Preferably, one side of the elastomeric piece is fixedly connected with the upper shell or the lower shell.

Preferably, the other side of the elastomeric piece is provided with elastomeric protrusions, and is in contact with the waist belt.

Preferably, the upper shell and/or the lower shell are/is provided with protrusions on a side facing the second space.

Preferably, the protrusions comprise raised ribs, toothed structures and conical protrusions.

Preferably, the upper shell and/or the lower shell are/is provided with raised ribs, and the protrusions are arranged on the raised ribs.

Preferably, an extension direction of the raised ribs is different from an extension direction of a length of the waist belt.

Preferably, both the upper shell and the lower shell are provided with protrusions, and positions of the protrusions on the upper shell are in one-to-one correspondence with positions of the protrusions on the lower shell.

Preferably, both the upper shell and the lower shell are provided with protrusions, and positions of the protrusions on the upper shell are different from positions of the protrusions on the lower shell.

Preferably, the lower shell is configured in a generally recessed shape, and a space between a recessed portion of the lower shell and the upper shell forms the second space.

In the embodiments of the present application, a technical solution in which the seat belt adjuster for vehicles is clamped and fixed at any position of the waist belt and the shoulder belt is routed over the seat belt adjuster is utilized, so that the position and the angle of the shoulder belt can be adjusted, to effectively adapt to occupants having different heights and body types, thereby improving the riding safety of occupants. Thus, it can be seen that the seat belt adjuster for vehicles in the embodiments of the present application can ensure the riding safety of occupants, especially occupants whose average figures are quite different from the average figure of adults, such as children, very thin occupants and very tall occupants.

### BRIEF DESCRIPTION OF DRAWINGS

The technical solution of the present application and its beneficial effects will become apparent in the detailed description of specific embodiments of the present application with reference to the accompanying drawings.

FIG. 1 is a schematic structural view of a seat belt adjuster for vehicles provided in Embodiment 1 of the present application;

FIG. 2 is an exploded view of the structure of the seat belt adjuster for vehicles provided in Embodiment 1 of the present application;

FIGS. 3 and 4 are schematic structural views of an upper shell provided in Embodiment 1 of the present application;

FIG. 5 is a schematic structural view of a middle disk provided in Embodiment 1 of the present application;

FIG. 6 is a schematic structural view of a first elastomeric member provided in Embodiment 1 of the present application;

FIGS. 7 and 8 are schematic structural views of a lower shell provided in Embodiment 1 of the present application;

FIG. 9 is a schematic structural view of a bearing provided in Embodiment 1 of the present application;

FIG. 10 is a schematic structural view of a sliding structure provided in Embodiment 1 of the present application;

FIG. 11 is a schematic structural view of a second elastomeric member provided in Embodiment 1 of the present application;

FIG. 12 is a schematic structural view of a lower shell cover provided in Embodiment 1 of the present application;

FIG. 13 is a schematic structural view of a seat belt adjuster for vehicles provided in Embodiment 2 of the present application;

FIG. 14 is an exploded view of the structure of the seat belt adjuster for vehicles provided in Embodiment 2 of the present application;

FIG. 15 is a side structural view of an upper shell of the seat belt adjuster for vehicles provided in Embodiment 2 of the present application;

FIG. 16 is a schematic structural view of the upper shell of the seat belt adjuster for vehicles shown in FIG. 3 from another perspective;

FIG. 17 is a schematic structural view of a lower shell of the seat belt adjuster for vehicles provided in Embodiment 2 of the present application;

FIG. 18 is a schematic structural view of a lower shell of another seat belt adjuster for vehicles provided in Embodiment 2 of the present application;

FIG. 19 is a schematic structural view of an elastomeric piece provided in Embodiment 2 of the present application; and

FIG. 20 is a schematic structural view of a snap lock provided in Embodiment 2 of the present application.

### REFERENCE NUMBERS IN FIGURES

1—leather sheath of upper shell;
2—upper shell; 201—screw stud; 210—leather sheath clamping slot of upper shell; 211—reinforcing rib;
3—middle disk; 301—screw via-hole; 302—hook of middle disk; 304—toothed structure of middle disk; 305—middle disk bearing;
4—first elastomeric member; 404—elastic gasket;
5—lower shell; 502—hook via-hole; 504—toothed structure of lower shell; 505—lower shell bearing; 506—lower shell fixing post; 507—elastic structure fixing support; 508—first sliding hole; 512—leather sheath clamping slot of lower shell;
6—bearing part; 605—bearing;
7—sliding part; 702—hook groove of sliding structure; 706—second sliding hole; 707—elastic structure fixing support of sliding structure; 708—sliding switch;
8—second elastomeric member; 807—spring;
9—lower shell cover; 902—clearance hole; 906—fixing hole of lower shell cover; 11—leather sheath of lower shell;
10—upper shell; 1001—upper shell body; 1002—snap-fit position of upper shell; 1003—bearing of upper shell; 1004—extension arm; 1005—upper shell protrusion;
20—lower shell; 2002—snap lock mounting slot of lower shell; 2005—lower shell protrusion; 2006—raised rib; 2003—bearing of lower shell;
30—elastomeric piece; 3001—first side of elastomeric piece;
40—snap lock; 4002—snap lock groove;
50—bearing part.

### DETAILED DESCRIPTION OF EMBODIMENTS

The technical solution in the embodiments of the present application will be described below clearly and completely with reference to the accompanying drawings in the embodiments of the present application. Apparently, the embodiments described herein are only some embodiments of the present application rather than all embodiments of the present application. Those skilled in the art can obtain other embodiments based on the embodiments provided herein without expending any creative effort; however, all those embodiments shall be deemed as falling in the scope of protection of the present application.

### Embodiment 1

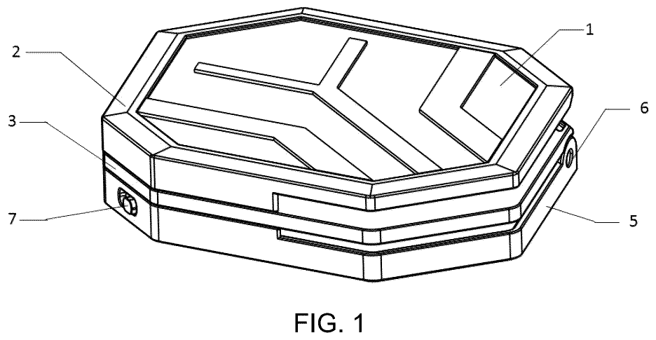

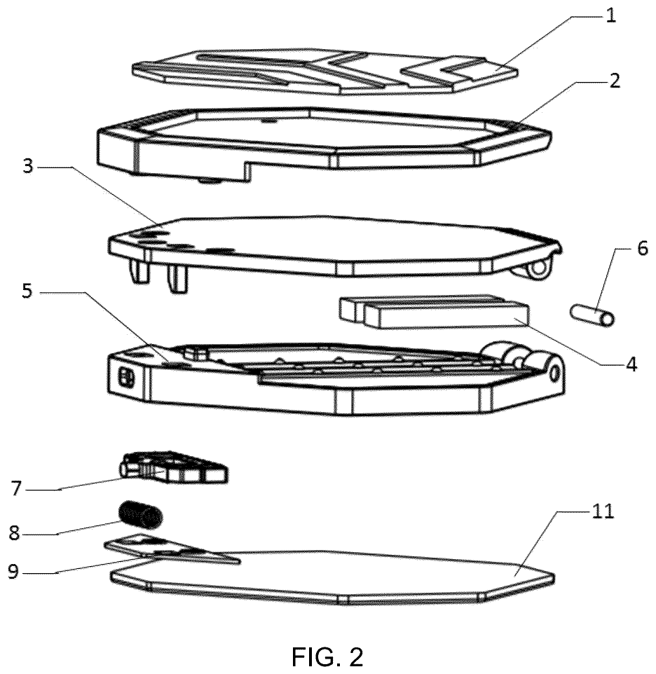

Please refer to FIGS. 1 and 2. FIG. 1 is a schematic structural view of a seat belt adjuster for vehicles provided in Embodiment 1 of the present application, and FIG. 2 is an exploded view of the structure of the seat belt adjuster for vehicles provided in Embodiment 1 of the present application. The Embodiment 1 of the present application provides a seat belt adjuster for vehicles, in particular a seat belt adjuster for a vehicle seat with a three-point seat belt installed thereon.

In some optional embodiments, in order to improve safety, the seat belt adjuster in Embodiment 1 of the present application is made of zinc alloy, thereby the strength of the seat belt adjuster is ensured to ensure safety, and the manufacturing cost is effectively controlled.

Of course, in some other optional embodiments, other high-strength alloys or hard materials, such as high-molecular polymers and plastics, may also be used, and there is no specific restriction on the material herein.

Specifically, please continue to refer to FIGS. 1 and 2. The seat belt adjuster provided in Embodiment 1 of the present application comprises an upper shell 2, a middle disk 3 and a lower shell 5, wherein the upper shell 2 and the middle disk 3 are fixedly connected together, and the middle disk 3 is rotatably connected with the lower shell 5.

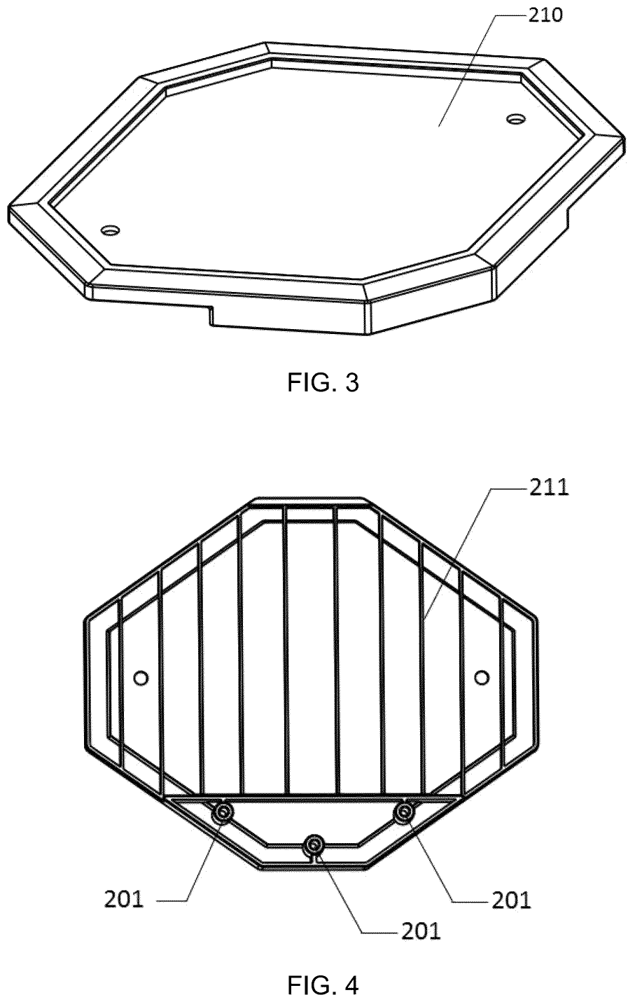

Please continue to refer to FIGS. 1 and 3. FIG. 3 is a schematic structural view of an upper shell provided in Embodiment 1 of the present application. A first space for receiving a shoulder belt to pass therethrough is formed by arranging a notch in a side of the upper shell 2 that faces the middle disk 3, and the width of the notch is equivalent to the width of the soft belt of the three-point safety belt pre-installed in the vehicle.

In some optional embodiments, the width of the notch may be slightly greater than the width of the soft belt to ensure the reliability of the shoulder belt after the shoulder belt passes through the first space.

It can be understood that the width of the notch may also be slightly smaller than the width of the soft belt, as long as it can ensure that the shoulder belt can be clamped and diverted from its position and direction after the shoulder belt passes through the first space.

It can also be understood that the notch may alternatively be arranged in the middle disk 3, and there is no specific restriction herein on the specific arrangement.

In some optional embodiments, the first space has no opening only at one end where the fixed connection locates.

In some embodiments, a side of the upper shell 2 that faces away from the middle disk 3 is provided with a leather sheath clamping slot 210 of the upper shell, and a leather sheath 1 of the upper shell may be arranged in the leather sheath clamping slot 210 of the upper shell. In view that the temperature of a seat belt adjuster made of an alloy material will change with the temperature inside the vehicle when the vehicle is parked for a long time in summer or winter, the leather sheath 1 of the upper shell can prevent the seat belt adjuster from getting so hot that the occupant is scalded, thereby improving the safety; and, the leather sheath 1 of the upper shell can prevent the seat belt adjuster from getting so cold that the occupant has a poor experience in the case that the occupant directly contacts with a seat belt adjuster made of an alloy material; thus, leather sheath 1 of the upper shell can improve the comfort of the occupant when the occupant contacts the seat belt adjuster.

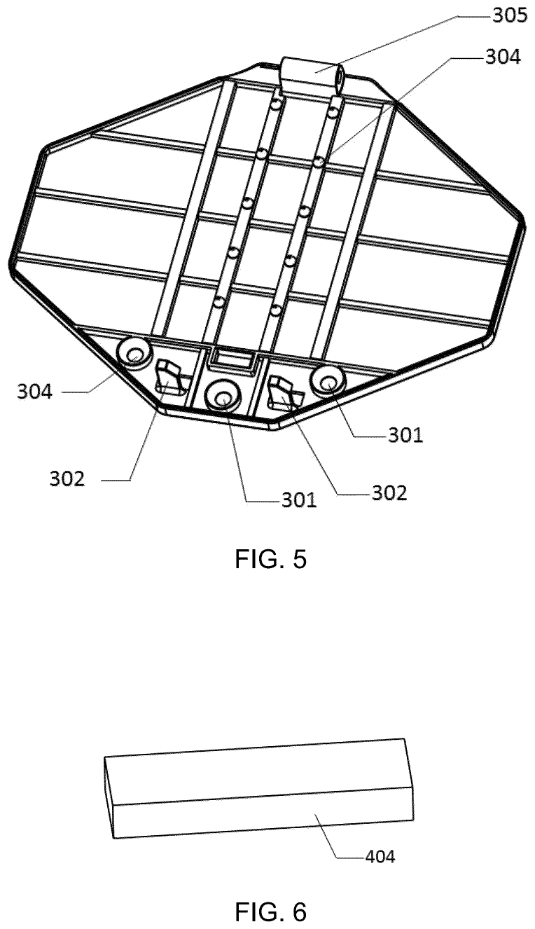

Please continue to refer to FIGS. 4 and 5. FIG. 4 is a schematic structural view of an upper shell provided in Embodiment 1 of the present application, and FIG. 5 is a schematic structural view of a middle disk provided in Embodiment 1 of the present application. In an optional embodiment provided by Embodiment 1 of the present application, a plurality of screw studs 201 are arranged at an end of the upper shell 2, and a plurality of screw via-holes 301 are arranged in the middle disk 3 at corresponding positions, and the upper shell 2 and the middle disk 3 are fixedly connected at an end with screws to form a fixed connection end.

It can be understood that it is also possible to arrange a plurality of screw studs 201 in the middle disk 3 and arrange a plurality of screw via-holes 301 in the upper shell 2, and there is no particular restriction on the specific arrangement herein.

In some embodiments, a plurality of reinforcing ribs 211 may be arranged on a side of the upper shell 2 that faces the middle disk 3. The reinforcing ribs 211 can not only further increase the strength of the upper shell, but also improve the stability of the shoulder belt in the seat belt adjuster after the shoulder belt passes through the seat belt adjuster, thereby improving the reliability and safety of the product.

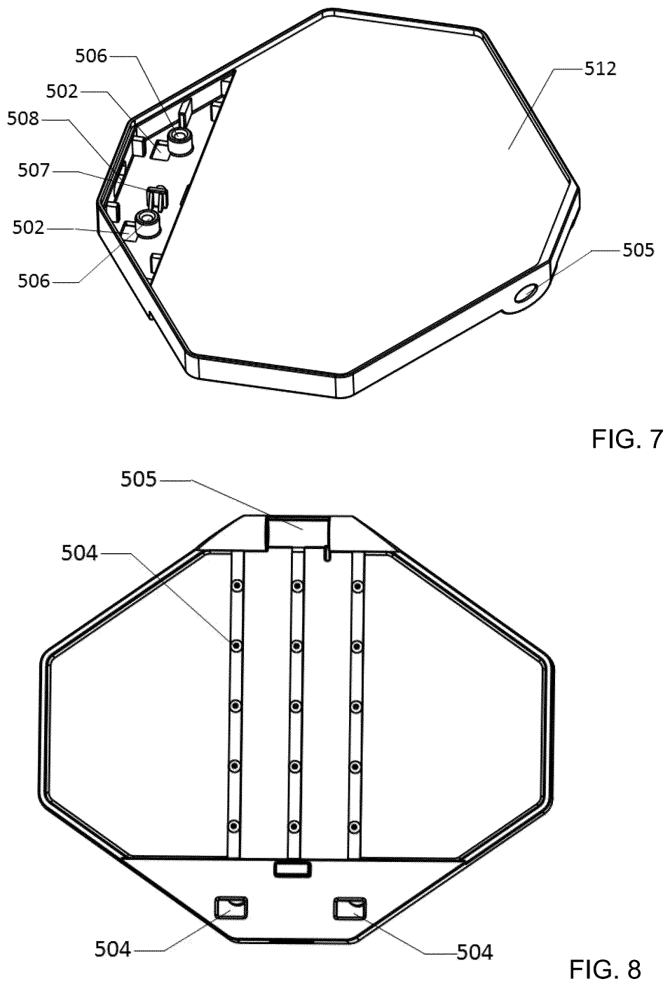

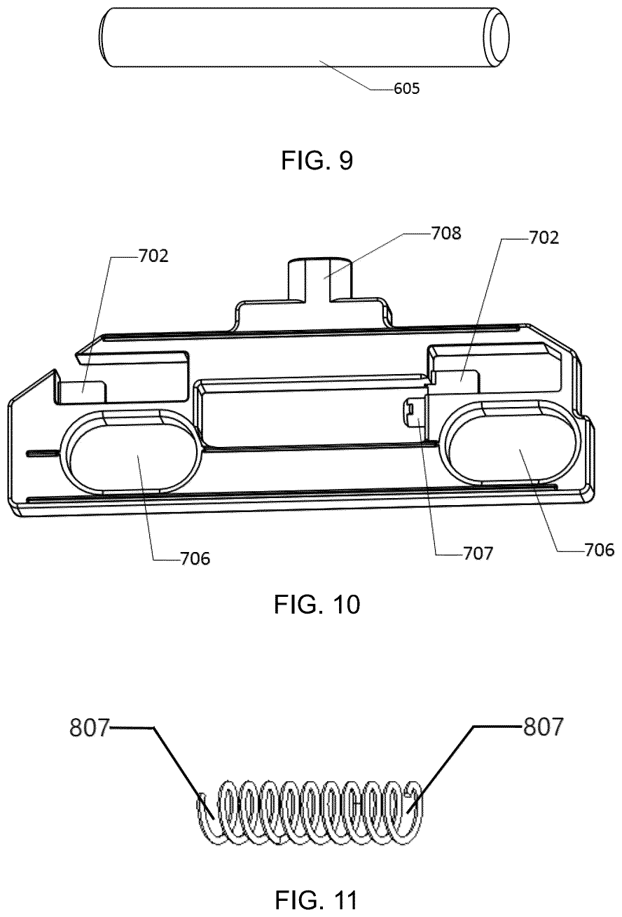

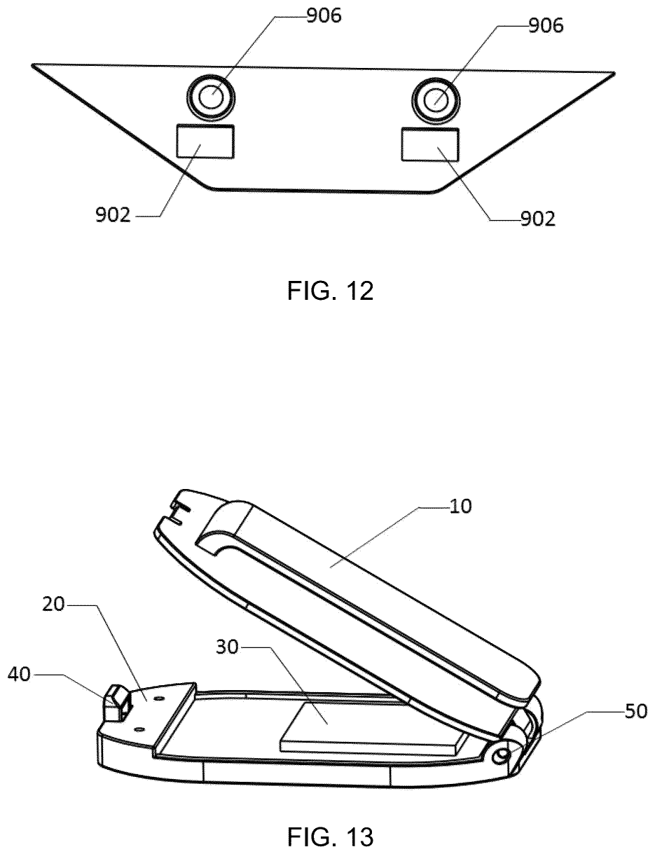

Please continue to refer to FIGS. 5 to 10. FIG. 6 is a schematic structural view of a first elastomeric member provided in Embodiment 1 of the present application; FIGS. 7 and 8 are schematic structural views of a lower shell provided in Embodiment 1 of the present application; FIG. 9 is a schematic structural view of a bearing provided in Embodiment 1 of the present application; FIG. 10 is a schematic structural view of a sliding structure provided in Embodiment 1 of the present application; FIG. 11 is a schematic structural view of a second elastomeric member provided in Embodiment 1 of the present application; and FIG. 12 is a schematic structural view of a lower shell cover provided in Embodiment 1 of the present application. In an optional embodiment of the present application, the middle disk 3 may be provided with at least one hook 302 of the middle disk, and correspondingly, the lower shell 5 is provided with a hook via-hole 502 and a sliding part 7 at positions corresponding to the hook 302 of the middle disk, and a hook groove 702 of the sliding structure is arranged at a corresponding position of the sliding part 7; the hook 302 of the middle disk passes through the hook via-hole 502 and corresponds to the hook groove 702 of the sliding structure, thus forming a locking structure for the middle disk 3 and the lower shell 5.

It can be understood that in an optional embodiment provided in the present application, the sliding structure 7 is regarded as a portion of the lower shell 5.

It can also be understood that the hook 302 of the middle disk may be arranged on the sliding structure 7, and correspondingly, the hook groove 702 of the sliding structure may be arranged in the middle disk 3.

In some optional embodiments, the middle disk 3 is provided with a plurality of toothed structures 304 of the middle disk. Optionally, the plurality of toothed structures 304 of the middle disk are arranged in a plurality of parallel columns having approximately the same spacing therebetween.

In some optional embodiments, one side of the lower shell 5 that faces the middle disk 3 is provided with a plurality of toothed structures 504 of the lower shell. Optionally, the plurality of toothed structures 504 of the lower shell are arranged in a plurality of parallel columns having approximately the same spacing therebetween, and the plurality of toothed structures 504 of the lower shell are arranged in approximately the same direction as the toothed structures 304 of the middle disk.

Furthermore, the plurality of parallel columns arranged by the plurality of toothed structures 304 of the middle disk are staggered from the plurality of parallel columns arranged by the plurality of toothed structures 504 of the lower shell. The structure formed by the arrangement of the plurality of toothed structures 304 of the middle disk and the plurality of toothed structures 504 of the lower shell can clamp the waist belt after the waist belt passes through the seat belt adjuster, so that the seat belt adjuster is fixed on the waist belt.

In some optional embodiments, at least one first elastomeric member 4, such as an elastic gasket 404 made of silicone, is arranged between the plurality of parallel columns arranged by the plurality of toothed structures 304 of the middle disk 3, so as to further increase the clamping force applied by the waist belt after the waist belt passes through the seat belt adjuster and improve the reliability.

It can be understood that the first elastomeric member 4 may also be arranged between the plurality of parallel columns arranged by the plurality of toothed structures 504 of the lower shell.

In some optional embodiments, the elastic gasket is in thickness of 1.8 cm to adapt to thickness criteria of different soft belts.

Please continue to refer to FIGS. 1 and 7. A second space for receiving the waist belt to pass therethrough is formed by arranging a notch in a side of the lower shell 5 that faces the middle disk 3, and the width of the notch is equivalent to the width of the soft belt of the three-point safety belt pre-installed in the vehicle.

In some optional embodiments, the width of the notch may be slightly greater than the width of the soft belt to ensure the reliability of the waist belt after the waist belt passes through the second space.

It can be understood that the width of the notch may alternatively be slightly smaller than the width of the soft belt, as long as the locking structure can lock the waist belt after the waist belt passes through the second space.

It can also be understood that the notch may alternatively be arranged in the middle disk 3, and there is no particular restriction herein on the specific arrangement.

In some optional embodiments, a middle disk bearing 305 is arranged at an end of the middle disk 3 away from the fixed connection end, and a lower shell bearing 505 is arranged on the lower shell 5 at a corresponding position. The middle disk bearing 305 and the lower shell bearing 505 jointly form a fixed rotational shaft through a bearing part 6, so that the middle disk 3 and the lower shell 6 form a rotational connection via the fixed rotational shaft. Wherein, the bearing part 6 may be a bearing 605 made of a metal material.

Furthermore, since one end of the rotational connection is away from the fixed connection end and the second space is located between one end of the rotational connection and the fixed connection end, the waist belt will not fall off in the width direction of the soft belt after passing through the seat belt adjuster and the locking structure is closed, and the plurality of parallel columns arranged by the toothed structures 304 of the middle disk, the plurality of parallel columns arranged by the toothed structures 504 of the lower shell and the elastic gasket 404 jointly ensure that the position of the seat belt adjuster in the length direction of the soft belt will not change, thereby creating a more stable fixing effect.

In some optional embodiments, the lower shell 5 is provided with a first sliding hole 508, and the sliding part 7 is provided with a sliding switch 708, the sliding switch 708 passes through the first sliding hole 508 and is slidably connected with the first sliding hole 508. Wherein, the cross-sectional area of the first sliding hole 508 is greater than the cross-sectional area of the sliding switch 708, so that the sliding switch 708 can slide in the first sliding hole 508.

In some optional embodiments, the lower shell 5 is provided with at least one elastic structure fixing support 507, and the elastic structure fixing support 507 is also arranged on the side facing away from the middle disk. At least one second elastomeric member 8 is fixedly connected at one end thereof to the elastic structure fixing support, the sliding part 7 is provided with at least one elastic structure fixing support 707 of the sliding structure, and the other end of the second elastomeric member 8 is fixedly connected to the elastic structure fixing support 707 of the sliding structure. Thus, an elastic switch structure that can be elastically restored is formed. Optionally, the second elastomeric member 8 may be a spring 807.

In some optional embodiments, the lower shell 5 is provided with at least one lower shell fixing post 506, and the lower shell cover 9 is provided with at least one lower shell cover fixing hole 906 accordingly, so that the lower shell cover 9 can be fixedly connected with the lower shell 5 by screws. The lower shell cover 9 is arranged on the side of the lower shell 5 that faces away from the middle disk.

Furthermore, the sliding part 7 is provided with at least one second sliding hole 706, and the lower shell fixing post 506 passes through the second sliding hole 706, so that the sliding part 7 slides relative to the lower shell fixing post 506.

In some optional embodiments, the side of the lower shell 5 that faces away from the middle disk 3 is provided with a leather sheath clamping slot 512 of the lower shell, and a leather sheath 11 of the lower shell is mounted in the leather sheath clamping slot 512 of the lower shell. In view that the side of the lower shell 5 that faces away from the middle disk 3 will contact the waist of the occupant during use, the leather sheath of the lower shell may be made of sponge wrapped in PU leather, so as to improve the comfort of the occupant.

In some optional embodiments, the lower shell cover 9 is provided with at least one clearance hole 902 to make room for the hook 302 of the middle disk.

Specifically, in the embodiment provided in the present application, when the occupant uses the seat belt adjuster, the occupant shifts the sliding switch 708 first to drive the sliding part 7 to slide together with the sliding switch 708; at this point, the sliding switch 7 slides in the first sliding hole 508, and the second sliding hole 706 slides synchronously with respect to the lower shell fixing post 506, and the spring 80 is stretched, so that the hook groove 702 of the sliding structure is disengaged from the hook 302 of the middle disk, and the middle disk 3 and the lower shell 5 are rotated and opened with respect to each other. The occupant clamps the opened seat belt adjuster at a desired position of the waist belt, and closes the seat belt adjuster, so that the plurality of parallel columns arranged by the toothed structures 304 of the middle disk, the plurality of parallel columns arranged by the toothed structures 504 of the lower shell and the elastic gasket 404 jointly act on the waist belt to ensure that the seat belt adjuster is fixed at the fixed position of the waist belt. Then, the shoulder belt is pulled to pass through the first space between the upper shell 2 and the middle disk 3, thereby the position and direction of the shoulder belt is changed.

### Embodiment 2

The Embodiment 2 of the present application provides a seat belt adjuster for vehicles, which has a structure slightly different from the structure in Embodiment 1.

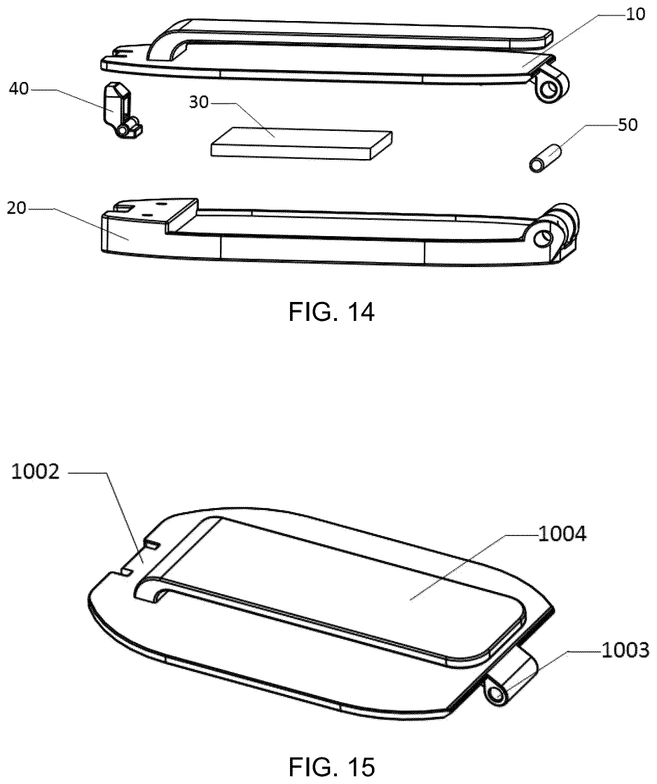

Please refer to FIGS. 13 and 14. FIG. 13 is a schematic structural view of a seat belt adjuster for vehicles provided in Embodiment 2 of the present application, and FIG. 14 is an exploded view of structure of the seat belt adjuster for vehicles provided in Embodiment 2 of the present application. The Embodiment 2 of the present application provides a seat belt adjuster for vehicles, in particular a seat belt adjuster for a vehicle seat with a three-point seat belt installed thereon.

In some optional embodiments, in order to improve safety, the seat belt adjuster in Embodiment 2 of the present application is made of zinc alloy, thereby the strength of the seat belt adjuster is ensured to ensure safety, and the manufacturing cost is effectively controlled.

Of course, in some other optional embodiments, other high-strength alloys or hard materials, such as high-molecular polymers and plastics, may also be used, and there is no particular restriction herein.

Specifically, please continue to refer to FIGS. 13 and 14. The seat belt adjuster provided in Embodiment 2 of the present application comprises an upper shell 10, a lower shell 20 and an elastomeric piece 30, wherein the upper shell 10 and the lower shell 20 are rotatably connected together via a bearing part 50, and the elastomeric piece 30 is arranged between the upper shell 10 and the lower shell 20, and locking structures are provided at an end of the upper shell 10 and an end of the lower shell 20.

Please continue to refer to FIG. 15. FIG. 15 is a side structural view of an upper shell of the seat belt adjuster for vehicles provided in Embodiment 2 of the present application. The upper shell 10 comprises an upper shell body 1001 and an extension arm 1004, wherein the upper shell body 1001 is configure in a planar shape, and the extension arm 1004 is configured approximately in an L-shape, an end of the extension arm 1004 is fixedly connected with the upper shell body 1001 to form a first space for a shoulder belt to pass therethrough, and the width of the first space is equivalent to the width of the shoulder belt of the three-point seat belt pre-installed in the vehicle; wherein the width of the first space is defined as a distance from the position where the extension arm 1004 is fixed connected with the upper shell body 1001 to the position of the other end of the extension arm 1004 projected on the upper shell body 1001; the width of the shoulder belt is the conventional width of the soft belt of the three-point seat belt, and will not be further detailed herein.

In some optional embodiments, the width of the notch may be slightly greater than the width of the soft belt to ensure the reliability of the shoulder belt after the shoulder belt passes through the first space.

It can be understood that the width of the notch may alternatively be slightly smaller than the width of the soft belt, as long as it can ensure that the shoulder belt can be clamped and diverted from its position and direction after the shoulder belt passes through the first space.

In some optional embodiments, a side of the upper shell 10 that faces away from the lower shell 20 is provided with a leather sheath clamping slot of the upper shell (not shown in the figure), and a leather sheath of the upper shell may be arranged in the leather sheath clamping slot of the upper shell. In view that the temperature of a seat belt adjuster made of an alloy material will change with the temperature inside the vehicle when the vehicle is parked for a long time in summer or winter, the leather sheath of the upper shell can prevent the seat belt adjuster from getting so hot that the occupant is scalded, thereby improving the safety; and the leather sheath of the upper shell can prevent the seat belt adjuster from getting so cold that the occupant has a poor experience in the case that the occupant directly contacts a seat belt adjuster made of an alloy material; thus, the leather sheath of the upper shell can improve the comfort of the occupant when the occupant contacts the seat belt adjuster.

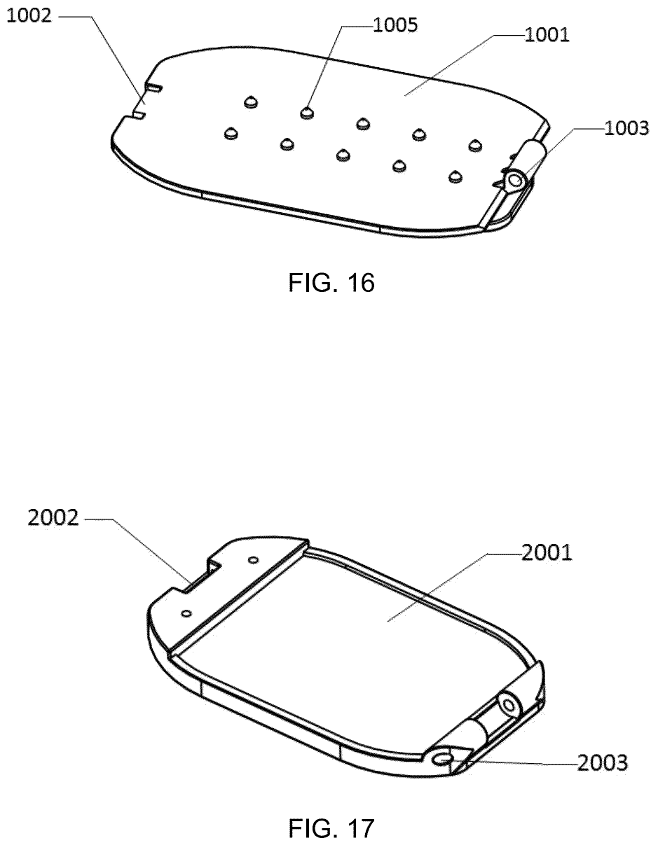

Please continue to refer to FIG. 16. FIG. 16 is a schematic structural view of the upper shell of the seat belt adjuster for vehicles shown in FIG. 15 from another perspective. In some optional embodiments, a plurality of upper shell protrusions 1005 may be arranged on the side of the upper shell 10 that faces the lower shell 20, so as to improve the stability of the shoulder belt in the seat belt adjuster after the shoulder belt passes through the seat belt adjuster for vehicles, thereby improving the reliability and safety of the product.

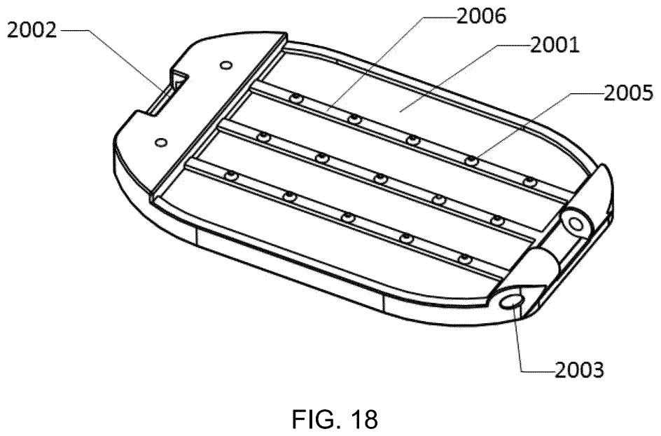

Please continue to refer to FIGS. 15 to 18. FIG. 17 is a schematic structural view of the lower shell of the seat belt adjuster for vehicles provided in Embodiment 2 of the present application, and FIG. 18 is a schematic structural view of the lower shell of another seat belt adjuster for vehicles provided in Embodiment 2 of the present application. In an optional embodiment of the present application, the upper shell 10 may be provided with at least one snap-fit position 1002 of the upper shell, and correspondingly, the lower shell 20 is provided with a snap lock mounting slot 2002 of the lower shell at a corresponding position. The snap lock 40 comprises a snap lock groove 4002, and a lower end of the snap lock 40 is rotatably connected with the lower shell 20 at the position of the snap lock mounting slot 2002 of the lower shell, and the snap lock groove 4002 can be locked with the snap-fit position 1002 of the upper shell.

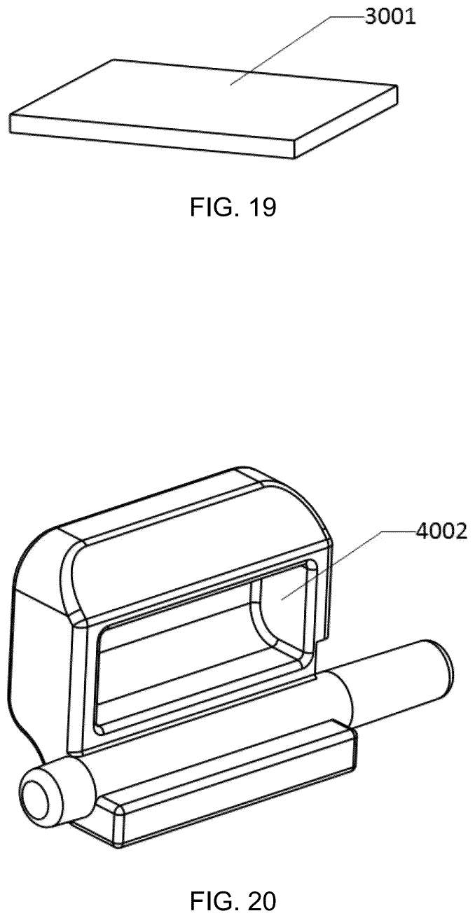

Please further refer to FIG. 20. FIG. 20 is a schematic structural view of a snap lock structure provided in Embodiment 2 of the present application. In an optional embodiment of the present application, the snap lock 40 further comprises a rotary bearing, and the snap lock 40 is rotatably connected with the lower shell 20 at the position of the snap lock mounting slot of the lower shell via the rotary bearing.

It can be understood that in an optional embodiment provided in the present application, the snap-fit position 1002 of the upper shell, the snap lock mounting slot 2002 of the lower shell and the snap lock 40 form a snap lock structure, wherein the snap-fit position 1002 of the upper shell is located at the end of the upper shell 10, namely a first end of the upper shell, and correspondingly, the snap lock mounting slot 2002 of the lower shell is located at an end of the lower shell 20, namely a first end of the lower shell, the first end of the upper shell and the first end of the lower shell are arranged correspondingly, and the snap lock 40 is arranged at the outer side of the first end of the upper shell and the outer side of the first end of the lower shell.

It can also be understood that the position of the snap-fit position 1001 of the upper shell and the position of the snap lock mounting slot 2002 of the lower shell may be exchanged, and the mounting direction of the snap lock 40 may be adjusted accordingly.

In some optional embodiments, the side of the lower shell 20 that faces the upper shell 10 is provided with a plurality of lower shell protrusions 2005. Optionally, the plurality of lower shell protrusions 2005 are arranged in a plurality of parallel columns having approximately the same spacing therebetween.

In some optional embodiments, the side of the lower shell 20 that faces the upper shell is provided with a plurality of raised ribs 2006, and a plurality of lower shell protrusions 2005 are arranged on some of the raised ribs. The plurality of lower shell protrusions 2005 are arranged in a plurality of parallel columns having approximately the same spacing therebetween; the extension direction of the plurality of parallel columns is different from the extension direction of the waist belt, so that the clamping force applied by the waist belt can be increased during use after the waist belt passes through the seat belt adjuster, thereby improving the reliability.

In some optional embodiments, the side of the lower shell 20 that faces the upper shell 10 is provided with a plurality of lower shell protrusions 2005. Optionally, the plurality of lower shell protrusions 2005 are arranged in a plurality of parallel columns having approximately the same spacing therebetween, and the plurality of lower shell protrusions 2005 are arranged in approximately the same direction as the upper shell protrusions 1005.

Furthermore, the plurality of parallel columns arranged by the plurality of upper shell protrusions 1005 are staggered from the plurality of parallel columns arranged by the plurality of lower shell protrusions 2005. The structure formed by the arrangement of the plurality of upper shell protrusions 1005 and the plurality of lower shell protrusions 2005 can clamp the waist belt after the waist belt passes through the seat belt adjuster, so that the seat belt adjuster is fixed on the waist belt.

It can be understood that both the upper shell 10 and the lower shell 20 may be provided with raised ribs, or only one of them may be provided with raised ribs, and the upper shell protrusion 1005 and the lower shell protrusions 2005 may or may not be arranged on the raised ribs.

It can also be understood that in the case that both the upper shell 10 and the lower shell 20 are provided with raised ribs, the upper shell 10 may be provided with upper shell protrusions 1005 and the lower shell 20 may be provided with lower shell protrusion 2005 on corresponding raised ribs, and the upper shell protrusions 1005 and the lower shell protrusion 2005 may be arranged in approximately the same direction, and may be staggered from each other or correspond to each other in position.

Please refer to FIGS. 13 to 19. FIG. 19 is a schematic structural view of an elastomeric piece provided in Embodiment 2 of the present application. In some optional embodiments, an elastomeric piece 30 may be arranged in the second space between the upper shell 10 and the lower shell 20; specifically, an elastomeric piece 30 may be arranged on the upper shell body 1001 and/or the lower shell body 2001, which is to say, the elastomeric piece 30 may be arranged only on the upper shell body 1001, or the elastomeric piece 30 may be arranged only on the lower shell body 2001, or the elastomeric pieces 30 may be arranged on the upper shell body 1001 and the lower shell body 2001.

Furthermore, in the case that the upper shell body 1001 is provided with a plurality of raised ribs and/or a plurality of upper shell protrusions, elastomeric pieces 30 may be arranged between the plurality of parallel columns arranged by the plurality of raised ribs and/or the plurality of upper shell protrusions; similarly, in the case that the lower shell body 2001 is provided with a plurality of raised ribs and/or a plurality of lower shell protrusions, elastomeric pieces 30 may be arranged between the plurality of parallel columns arranged by the plurality of raised ribs and/or the plurality of lower shell protrusions. For example, the elastomeric piece 30 may be an elastic gasket made of silicone. During use, the elastomeric piece 30 is in contact with the waist belt, so as to further increase the clamping force applied by the waist belt after the waist belt passes through the seat belt adjuster, thereby improving the reliability.

In some optional embodiments, in the case that the upper shell body 1001 is provided with an elastomeric piece 30, a first side 3001 of the elastomeric piece 30 is fixedly connected with the upper shell body 1001, for example, by means of hot melt adhesive. The other side of the elastomeric piece, which is opposite to the first side of the elastomeric piece, may be provided with elastomeric protrusions. During use, the elastomeric protrusions are in contact with the waist belt, so as to further increase the clamping force applied by the waist belt after the waist belt passes through the seat belt adjuster, thereby improving the reliability.

In some optional embodiments, the elastomeric piece 30 is in thickness of 1.8 cm to adapt to thickness criteria of different soft belts.

In some optional embodiments, the thickness of the elastic gasket is greater than the height of the upper shell protrusions 1005;

In some optional embodiments, the thickness of the elastic gasket is greater than the height of the lower shell protrusions 2005.

Please continue to refer to FIGS. 13, 17 and 18. By arranging a recessed notch on the side of the lower shell 20 that faces the upper shell 10, the entire lower shell 20 is in a generally recessed shape, which works with the upper shell 10 to form a second space for receiving the waist belt to pass therethrough. The width of the notch is equivalent to the width of the soft belt of the three-point seat belt pre-installed in the vehicle.

In some optional embodiments, the width of the notch may be slightly greater than the width of the soft belt to ensure the reliability of the waist belt after the waist belt passes through the second space.

It can be understood that the width of the notch may alternatively be slightly smaller than the width of the soft belt, as long as the snap lock can lock the waist belt after the waist belt passes through the second space.

In some optional embodiments, the side of the lower shell 20 that faces away from the upper shell 10 is provided with a leather sheath clamping slot of the lower shell (not shown in the figure), and a leather sheath of the lower shell is mounted in the leather sheath clamping slot of the lower shell. In view that the side of the lower shell 20 that faces away from the upper shell 10 will contact the waist of the occupant during use, the leather sheath of the lower shell may be made of sponge wrapped in PU leather, so as to improve the comfort of the occupant.

Please refer to FIGS. 13 to 17. In some optional embodiments, the end of the upper shell 10 away from the snap lock structure is provided with an upper shell bearing 1003, and the lower shell 20 is provided with a lower shell bearing 2003 at a corresponding position. The upper shell bearing 1003 and the lower shell bearing 2003 jointly form a fixed rotational shaft via a bearing part 50, so that the upper shell 10 and the lower shell 20 are rotationally connected via the fixed rotational shaft. The bearing part 50 may be a bearing made of a metal material.

Furthermore, since the rotational connection end is away from the snap lock structure and the second space is located between the rotational connection end and the snap lock structure, the waist belt will not fall off in the width direction of the soft belt after passing through the seat belt adjuster and the snap lock structure is closed, and the plurality of parallel columns arranged by the upper shell protrusions 1005, the plurality of parallel columns arranged by the lower shell protrusions 2005 and the elastomeric piece 30 jointly ensure that the position of the seat belt adjuster in the length direction of the soft belt will not change, thereby forming a more stable fixing effect.

Please refer to FIGS. 13 and 20. In some optional embodiments, the snap lock 40 is provided with a shift switch, wherein the shift switch is higher than the upper shell 10 to facilitate being shifted.

Specifically, in an embodiment provided in the present application, when the occupant uses the seat belt adjuster, the occupant shifts the shift switch first to drive the snap lock 40 to rotate together with the shift switch; at this point, the snap lock 40 rotates around the rotary bearing, and the snap lock groove 4002 is disengaged from the snap-fit position 1002 of the upper shell, so that the upper shell 10 and the lower shell 20 can be rotated and opened with respect to each other. The occupant clamps the opened seat belt adjuster at a desired position of the waist belt, and closes the seat belt adjuster, so that the plurality of parallel columns arranged by the upper shell protrusions 1005, the plurality of parallel columns arranged by the lower shell protrusions 2005, the elastomeric piece 30 and the elastomeric protrusions jointly act on the waist belt to ensure that the seat belt adjuster is fixed at the fixed position of the waist belt. Then, the shoulder belt is pulled to pass through the first space of the upper shell 10, thereby the position and direction of the shoulder belt is changed.

In the above embodiments, the description of each embodiment has its own emphasis. For the parts not detailed in one embodiment, reference may be made to the related description of other embodiments.

While the seat belt adjuster provided in the embodiments of the present application is described in detail above and the principle of the present application and embodiments are described in detail above in specific embodiments, it should be appreciated that those embodiments are only intended to facilitate understanding the method and core idea of the present application; those having ordinary skills in the art can make modifications to the embodiments and the application scope on the basis of the idea of the present application. In summary, the content of this specification shall not be understood as constituting any limitation on the present application.

1. A seat belt adjuster for vehicles, comprising an upper shell, a middle disk and a lower shell, wherein
the upper shell and the middle disk are fixedly connected together, and a first space for receiving a shoulder belt to pass therethrough is formed between the upper shell and the middle disk;
the middle disk is rotatably connected with the lower shell, and a second space for receiving a waist belt to pass therethrough is formed between the middle disk and the lower shell, and locking structures are provided on the middle disk and the lower shell at corresponding positions.

2. The seat belt adjuster according to claim 1, characterized in that the middle disk is rotatably connected with the lower shell via a fixed rotational shaft.

3. The seat belt adjuster according to claim 2, characterized in that the fixed rotational shaft is arranged at an end of the middle disk and an end of the lower shell.

4. The seat belt adjuster according to claim 3, characterized in that the locking structures are arranged at an end of the middle disk away from the fixed rotational shaft and an end of the lower shell away from the fixed rotational shaft.

5. The seat belt adjuster according to claim 4, characterized in that the second space is arranged between the fixed rotational shaft and the locking structures.

6. The seat belt adjuster according to claim 4, characterized in that the upper shell and the middle disk are fixedly connected together at a position that is at the same end as the locking structures.

7. The seat belt adjuster according to claim 1, characterized in that the first space is arranged at an end away from the position where the upper shell and the middle disk are fixedly connected, and the first space has no opening only at an end of the fixed connection position.

8. The seat belt adjuster according to claim 1, characterized in that the seat belt adjuster further comprises an elastic switch structure, and the elastic switch structure is connected with the locking structures.

9. The seat belt adjuster according to claim 1, characterized in that a first elastomeric member is provided in the second space, and the first elastomeric member is fixedly connected to the upper shell or the middle disk.

10. The seat belt adjuster according to claim 1, characterized in that the upper shell and/or the middle disk are/is provided with toothed structures.

11. A seat belt adjuster for vehicles, comprising an upper shell, an elastomeric piece and a lower shell, wherein
the upper shell is configured generally in a U-shape or a C-shape to form a first space for a shoulder belt to pass therethrough; the upper shell and the lower shell are rotatably connected with each other at a first end of the upper shell and a first end of the lower shell; a second space for a waist belt to pass therethrough is formed between the upper shell and the lower shell; snap lock structures are provided at a second end of the upper shell and a second end of the lower shell; and the elastomeric piece is arranged in the second space, and the elastomeric piece is squeezed to clamp the waist belt after the upper shell and the lower shell are locked by means of the snap lock structures.

12. The seat belt adjuster according to claim 11, characterized in that one side of the elastomeric piece is fixedly connected with the upper shell or the lower shell.

13. The seat belt adjuster according to claim 12, characterized in that the other side of the elastomeric piece is provided with elastomeric protrusions, and is in contact with the waist belt.

14. The seat belt adjuster according to claim 11, characterized in that the upper shell and/or the lower shell are/is provided with protrusions on a side thereof facing the second space.

15. The seat belt adjuster according to claim 14, characterized in that the protrusions comprise raised ribs, toothed structures and conical protrusions.

16. The seat belt adjuster according to claim 15, characterized in that the upper shell and/or the lower shell are/is provided with raised ribs, and the protrusions are arranged on the raised ribs.

17. The seat belt adjuster according to claim 16, characterized in that the raised ribs extend in a direction different from a length direction of the waist belt.

18. The seat belt adjuster according to claim 14, characterized in that both the upper shell and the lower shell are provided with protrusions, and positions of the protrusions on the upper shell are in one-to-one correspondence with positions of the protrusions on the lower shell.

19. The seat belt adjuster according to claim 14, characterized in that both the upper shell and the lower shell are provided with protrusions, and positions of the protrusions on the upper shell are different from positions of the protrusions on the lower shell.

20. The seat belt adjuster according to claim 11, characterized in that the lower shell is configured generally in a recessed shape, and a space between a recessed portion of the lower shell and the upper shell forms the second space.
